(19) United States
(12) Patent Application Publication
(10) Pub. No.: US 2016/0005100 A1
(43) Pub. Date: Jan. 7, 2016

(54) Fueling Station Non-Fuel Item Display, Purchase, and Payment Systems

(71) Applicant: Signal Peak Design LLC, Lawrence, KS (US)

(72) Inventors: Scott Zaremba, Lawrence, KS (US); Peter Tawil, Costa Mesa, CA (US)

(73) Assignee: Signal Peak Design LLC, Lawrence, KS (US)

(21) Appl. No.: 14/747,824

(22) Filed: Jun. 23, 2015

Related U.S. Application Data
(60) Provisional application No. 62/020,500, filed on Jul. 3, 2014.

(51) Int. Cl. G06Q 30/06; G06Q 50/12; G06Q 30/02; B67D 7/04; G06Q 20/18

(52) U.S. Cl. CPC G06Q 30/0633; B67D 7/04; G06Q 20/18; G06Q 30/0279; G06Q 50/12; G06Q 30/0226; G06Q 30/0241

(57) ABSTRACT

Customers purchasing fuel from a dispenser may engage in non-fuel transactions using a tablet computing system affixed on or near a fuel dispenser. A tablet computer may be used to display information regarding available items, services, charitable opportunities, or other options to a fuel customer, receive inputs requesting additional information from the fuel customer, and/or receive an input indicating a desire to engage in a transaction from a fuel customer. Purchased items may be available for pick-up by a customer inside a store, available for pick-up at a drive through window, and/or delivered to the customer at a fuel dispenser. A payment mechanism may be provided in conjunction with the tablet computer. The tablet computer provided may be constructed in such a way to be protected from physical damage and weather.

### CROSS-REFERENCE TO RELATED APPLICATIONS

This application claims the benefit of provisional patent application Ser. No. 62/020,500, entitled “Fueling Station Non-Fuel Item Display, Purchase, and Payment Systems,” filed on Jul. 3, 2014, which is incorporated herein by reference.

### FIELD OF INVENTION

The present invention relates to hardware and software solution that allows for non-fuel item selection, ordering, payment processing, and/or other transactions at the fuel dispensers of fueling stations. More particularly, the present invention relates to systems and methods for use at a fuel dispenser located at a fueling station with an associated store or other facility to facilitate a customer's convenient selection and payment for convenience store items at a fuel dispenser while fueling.

### BACKGROUND AND DESCRIPTION OF THE RELATED ART

Beginning in 1986, American motorists increasingly have had the ability to pay for fuel purchases right at the fuel dispenser. This payment technology has made the fuel purchase experience more convenient and efficient for both the fuel customer and the fueling station, and therefore has attained wide availability and popularity. As of 2014, almost 70% of all fuel customers use this payment technology.

Another advancement that has created convenience and efficiency at fueling stations has been the creation of on-site restaurants, stores, and other facilities. A refueling stop may provide a driver or a passenger an opportunity for a meal, a snack, a drink, or the purchase of any of a variety of useful items that may be for sale within a store associated with the fueling station.

### SUMMARY OF THE INVENTION

Although more convenient than seeking a different store, for some motorists walking inside a store located at a fueling station is not feasible or desirable. Uncertainty as to what products may be available in the store may dissuade motorists from making a purchase beyond fuel to avoid a futile trip into a store seeking an item that may not be available. Occasionally, a customer may choose to pay for a fuel purchase at the dispenser, only to subsequently enter the convenience store to discover that the desired snack, drink, or other item is not available. The experience may leave the customer with ill-will towards the fueling station possibly dissuade the customer from returning. Many customers may prefer to purchase a desired snack, beverage, or other materials from a store without having to enter the store or restaurant, but that ability has previously been lacking Other transactions, such as transactions not involving the fueling station and any associated store, could not be completed at a fuel dispenser without using equipment (such as a mobile phone) provided by the customer.

In some examples, the present invention provides systems and methods that permit the selection and purchase of items from a store associated with a fueling station while a motorist is refueling. A “store” may be any type of convenience store, restaurant, rental facility, or other retail establishment. The present invention may comprise a ruggedized, touch-enabled tablet PC or similar computing device, referred to as a “tablet” herein, that operates software to present information describing items available for purchase during the time a motorist is refueling. A tablet used in conjunction with the present invention may be UL certified or otherwise approved for use in the environment of a fuel dispenser at a fueling station. A motorist may obtain additional information and/or select items for purchase by touching the screen to indicate items of possible interest. An associated payment mechanism may receive a payment for the purchased items via credit card, debit card, Near Field Communication (“NFC”), infrared scanning, barcode readers, QR readers, and/or other means. The tablet, with or without an associated payment mechanism, may be constructed to withstand the rigors of the outdoors and the fuel dispensing environment.

In some examples of the present invention, once a customer has completed selections from the tablet, the selected materials may be gathered or prepared within the store by a station employee or automated means and may then be made available for subsequent pickup by a customer. For example, a customer may be able to pick up his or her purchase at a drive-through window or at a pickup counter conveniently located within the store. In another example, purchased items may be delivered to the customer at the fuel dispenser or other appropriate location, whether by staff or through a mechanical conveyance. By way of a further example, a customer may purchase or otherwise obtain a non-tangible non-fuel item, which may be delivered to the customer via the tablet itself or through other digital means to a customer or the customer's personal computing device. Accordingly, a motorist is provided an opportunity to make selections and purchases during the time they would have otherwise spent waiting for refueling to be complete. In this manner, systems and methods in accordance with the present invention provide beneficial sales to a fueling station while enhancing the convenience and overall experience of both fuel and non-fuel customers.

Systems and methods in accordance with the present invention may be used to facilitate a number of transactions. One particularly useful and convenient type of transaction described in examples herein involves the purchase of non-fuel items while a motorist is refueling. However, other transactions may be implemented or facilitated using systems and methods in accordance with the present invention. For example, customers may enroll in or manage a loyalty program associated with the fueling station, purchase non-physical items such as gift codes or lottery entries, or otherwise interact with the station and associated endeavors. By way of a further example, fuel customers may play games or otherwise entertain themselves by selecting videos or other types of media to enjoy (for free or for a fee) using systems and methods in accordance with the present invention.

As a yet further example of systems and methods in accordance with the present invention, sales, offers, loyalty programs, and other interactions facilitated by a tablet deployed at a fuel dispenser in accordance with the present invention may involve third parties and third party organizations, such as charities or businesses. For example, a tablet may be used to facilitate donations to charitable organizations in conjunction with a fuel purchase. In other examples, a tablet may present to a fuel customer the option to purchase goods or services from third parties while fueling his or her vehicle. Such goods or services may be located within a short drive from the fuel station, but need not be. The tablet may display information describing the charity, good, or service while the customer dispenses fuel, and may thereafter facilitate the donation or purchase. There is no limit to the types or varieties of donations that may be made in such a fashion. Similarly, the types of goods or services that may be sold are numerous and varied. For example, a customer might opt to pre-purchase an oil change for his or her vehicle, or schedule a take-out food order, or purchase flowers, or make any other purchase of goods or services while fueling, whether those goods and/or services are related to the customer's vehicle or not.

### BRIEF DESCRIPTION OF THE SEVERAL VIEWS OF THE DRAWINGS

Examples of systems and methods in accordance with the present invention are described in conjunction with the attached drawings, wherein:

FIG. 1 schematically illustrates an example of a system in accordance with the present invention;

FIG. 2 illustrates an example of a fuel dispenser, a tablet computing device, and a fueling station store in accordance with the present invention;

FIG. 3 illustrates an example of a customer facing selection touch-enabled display in accordance with the present invention;

FIG. 4 illustrates an example of an internal component mounting system in accordance with the present invention;

FIG. 5 illustrates an example of a rear cover that affixes to a fuel dispenser mounting bracket in accordance with the present invention;

FIG. 6 illustrates a further example of a fuel dispenser mounting bracket in accordance with the present invention;

FIG. 7 schematically illustrates an example tablet computing device coupled with a fuel dispenser;

FIG. 8 schematically illustrates an example of a tablet computing device that may be used in accordance with the present invention; and

FIG. 9 illustrates an example of a method for facilitating non-fuel transactions at a fuel dispenser in accordance with the present invention.

### DETAILED DESCRIPTION

Systems and methods in accordance with the present invention provide a convenient opportunity for a customer purchasing fuel to select and purchase products from a store associated with the fueling station, to conduct other transactions, or to be entertained without leaving the fuel dispenser. The present invention may utilize a tablet computing device to present information describing products available for purchase or acquisition to a customer, to inform the customer of various offers from third parties available to a fuel customer and to facilitate those transactions, and to otherwise interact with a customer. Products may comprise food and beverage items, convenience items, entertainment items, games, affinity programs, loyalty programs, or any other tangible or intangible item or status.

Systems and methods in accordance with the present invention may utilize a tablet computing device retrofitted to an existing fuel dispenser, but may comprise an entirely new fuel dispenser system. Because of the fueling station environment and the potentially hazardous materials that could come into contact with a tablet computing device at or near a fuel dispenser, a tablet computing device in accordance with the present invention may be protected from environmental hazards such as corrosive and/or flammable gases and liquids. Further, a tablet computing device in accordance with the present invention may be electrically coupled to a power source in a fashion that prevents shorting. Similarly, internal electrical connections within the tablet computing device and its optional associated components, such as cooling fans and communications interfaces, may be secured to prevent discharge or shorting. For example, mechanical fasteners may be used in conjunction with epoxies or other adhesives to both electrically connect components in accordance with the present invention and to prevent the accidental or intentional (particularly due to tampering) shorting or severing of the electrical connection. While a tablet computing device and the associated components may work using alternating current or direct current of various voltages, one example of a tablet in accordance with the present invention may use a 110 volt alternating current electrical connection to power a 12 volt direct current power supply that powers the tablet computing device and its constituent components.

A tablet computing device may be protected with a variety of physical enclosures in accordance with the present invention. In one example, 16 gauge aluminum with a folded metal welded construction may enclose a tablet computing device. Other types of metal and/or other thicknesses of metal may by used in accordance with the present invention. Seams in such an exemplary enclosure may be sealed with weatherproof gaskets. The screen of a tablet computing device, which may often be an LCD display with an LED backlight, may be protected by a sheet of protective material, such as a 1/16-⅛ inch thick plastic sheet, tempered glass, or polycarbonate sheet, although other thicknesses and other types of materials may be used to protect the screen of a tablet computing device at a fuel dispenser in accordance with the present invention.

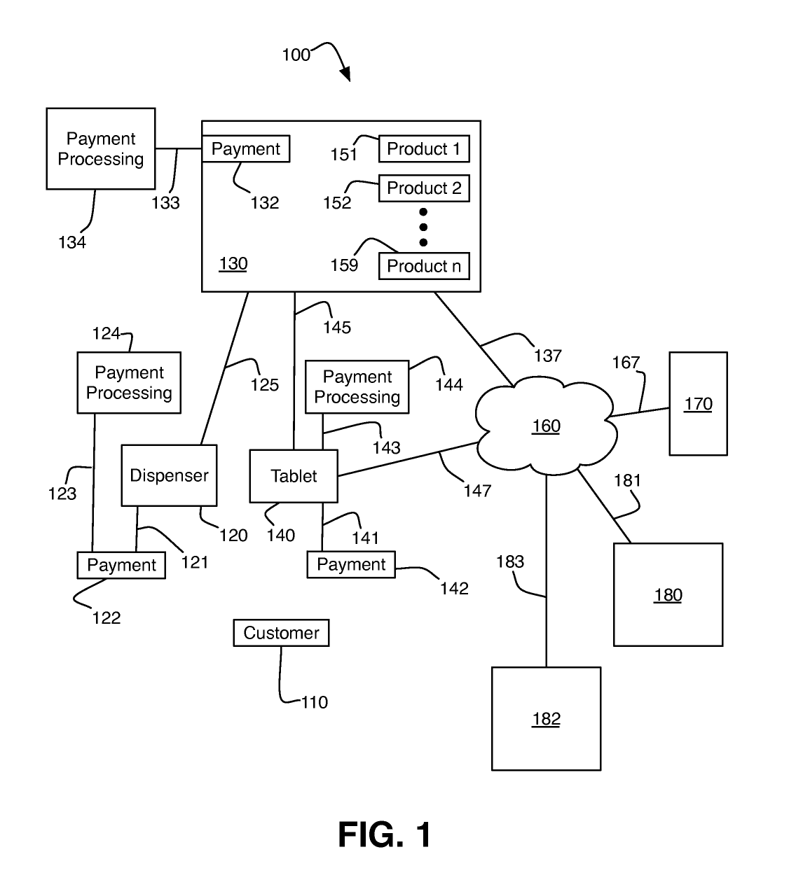

An example of a system 100 in accordance with the present invention is illustrated schematically in FIG. 1. A customer 110 may comprise any individual purchasing fuel from a fuel dispenser 120, or an individual in the company of a person purchasing fuel. Customer 110 may elect to use a payment system 122 associated in communication 121 with dispenser 120 to pay for purchased fuel, often known as a “pay-at-the-pump” system. The payment system 122 may interface 123 with a payment processing system 124. Payment processing system 124 may comprise a banking system, a credit card processor, or any other equipment/entity that may process payments made via the payment system 122 to transfer an appropriate amount of funds to cover the fuel purchase made by customer 110. The interface 123 between payment system 122 and payment processing 124 may be via any kind of communication mechanism or media and may use any kind of protocol, such as a telephone connection, a data connection, a wireless link, or other type of communication network.

As can be seen in the example of FIG. 1, a tablet 140 affixed on or near the dispenser 120 may be used to display information regarding items available for purchase by customer 110 and/or to permit a customer 110 to browse and optionally select transactions for commercial, charitable, and/or entertainment purposes. In many examples in accordance with the present invention, a tablet 140 may be affixed to an associated dispenser 120 to provide tablet 140 with a mounting location and power source.

Customer 110 may use tablet 140 to select items for purchase or to obtain additional information regarding items available for purchase, or to conduct a variety of other commercial, charitable, and/or entertainment transactions. As described in further detail herein, tablet 140 may comprise a general purpose or specially provided computing device. Tablet 140 may have a touch-enabled display able to display information describing available products, services, and/or other transaction, and may also receive touch-based inputs from customer 110 to indicate customer selections. Optionally, one or more audio output device, such as one or more speaker or headphone jack, may by provided by tablet 140 or as part of dispenser 120 under the control of tablet 140. Also optionally, one or more additional input device instead of or in addition to the touch sensitive screen of tablet 140 may be provided as part of tablet 140 and/or as part of dispenser 120 connected to tablet, such that the one or more additional input device may be optionally used by a customer 110 to indicate selections and to generally interact with tablet 140. Examples of such additional input devices include, but are not limited to, buttons, switches, motion detectors, keypads, a computer mouse, a track pad, a pedal, a lever, or any other type of device that may be used to register a selection or an input by a customer 110.

One or more computer processor(s) in tablet 140 may interface with memory and/or storage provided as part of tablet 140 or accessible to tablet 140 in order to access data and/or machine readable code retained in a non-transitory medium or media to cause the computer processor integral to and/or remote from tablet 140 to execute methods in accordance with the present invention and to operate as part of a system in accordance with the present invention. Tablet 140 may interface with other computing devices, such as servers, other tablets, other PCs, and/or embedded computing devices, all or some of which may be executing machine readable code to operate in conjunction with the present invention. Such other computing devices may be on-site and/or off-site computer servers accessed via secure communication lines to execute customer initiated commands. Systems and methods in accordance with the present invention may retain relevant databases or other data storage systems to provide information for display or other use by tablet 140, for the maintenance of sales or transaction records, for diagnostic or operational purposes, or for any other reason. For example, product information, such as available products, available services, product pricing, service pricing, games or entertainment media, charitable campaigns, loyalty programs, discounts or other promotions available, informational content, and other information or data, may be stored in computer memory on tablet 140 and/or otherwise accessible to tablet 140 as needed.

Tablet 140 may interface 141 with a payment system 142 to receive a payment from customer 110 for any transactions requiring a payment initiated by customer 110 using tablet 140. For example, customer may select items for purchase via tablet 140. Tablet 140 may interface 143 with a payment processing system 144 to process payments made for items selected and purchased using tablet 140. Payment processing system 144 may be the same payment processing system 124 used for processing payments for fuel obtained from dispenser 120, but may be a different system or service. Payment system 142 may read credit cards (or other magnetic strips), use Near Field Communication (NFC), read barcodes or QR codes (for example, using a laser scanner or other techniques), receive cash in the form of bills and/or coins, or operate to receive any other form/type payment from a fuel customer.

In many examples, tablet 140 may facilitate the purchase of tangible items from a store 130 associated with the fuel station managing and providing dispenser 120, but store 130 may be any entity providing an available transaction, commercial or non-commercial, to customer 110 via tablet 140 while customer fuels from dispenser 120. Store 130 may include a variety of products,/services such as a first product 151, a second product 152, and so on through an nth product 159. While generally described as a store 130, store may comprise a convenience store, a restaurant, movie or other media rental facility, or any other type of commercial establishment, in all or in part. In some examples, a store 130 may comprise a third party business or charity that receives donations via tablet 140 or sells its goods and/or services via tablet 140.

Systems and methods in accordance with the present invention need not be limited to a single store. For example, in addition to a first store 130, a second store 180, a third store 182, and any number of additional stores may offer transactions via tablet 140 to a customer 110 fueling at dispenser 120. While generally described as a “store” herein, any or all of first store 130, second store 180, third store 182, and/or additional stores may provide customer 110 the opportunity to engage in transactions that are not entirely or even partially commercial in nature. For example, a store may provide customer 110 an opportunity to donate or otherwise support a charity. One or more store may alternatively/additionally offer the opportunity to join or update a loyalty program, to purchase goods or services associated with a station, to purchase good or services located near the station, and/or to purchase goods or services located a great distance from the (such as would require tangible products purchased to be provided to customer 110 by a package delivery). In other examples in accordance with the present invention, a store may provide intangible items for purchase or a non-purchase acquisition by customer 110. Examples of non-tangible items a customer 110 may purchase may be music files, video files, games, entries into sweepstakes or lotteries, etc. Non-tangible items purchased or otherwise acquired by customer 110 may be transitorily provided to customer via tablet 140 while customer 110 is fueling, but may be electronically provided to customer 110 (or a computing device operated by customer 110) via any electronic delivery mechanism. For example, a purchased or otherwise acquired non-tangible item may be available for download from an identified Internet address (or through other network resource location system) with an associated passcode. In other examples, a purchased non-tangible item may be transferred to a device associated with customer 110 via a data connection or a wireless protocol while customer 110 fuels from dispenser 120.

Typically, a store 130 may have a payment processing system 132 with an interface 133 to a payment processor 134. Payment processor 134 may be the same or different than the payment processor 124 associated with purchases made at dispenser 120 and/or the payment processor 144 associated with tablet 140 for items selected and purchased via tablet 140. Network connections may extend between one or more computing device within store 130, dispenser 120, and/or tablet 140. Network connections 125, 145, may be used to exchange information relevant to or recording purchases made, products to be made available for or to be delivered to customer 110, issues regarding payment processing, and/or for any other purpose.

Further, a network 160, which may comprise the Internet or any other computer network, may be available to any or all of store 130, tablet 140, and dispenser 120. In the example illustrated in FIG. 1, an Internet connection 137 permits computing devices located within store 130 to access Internet 160 and, ultimately, establish a link 167 to a remote server 170. Similarly, an Internet connection 147 permits tablet 140 to access Internet 160 and ultimately establish a connection 167 to server 170. Server 170 may comprise a single computing device, but may also comprise one or more computing device. Server 170 may comprise a single server, multiple servers, a peer-to-peer computer network, a distributed computing network, a multitude of potentially redundant servers, a cloud facility, or other type of computing system to provide information, such as available products/services/promotions, to control or facilitate the operations of tablet 140 or computing devices within store 130.

Connection to Internet 160 may take any form, such as any wired or wireless technology. In many instances, an Internet 160 connection may be obtained through a wired connection to an Internet Service Provider, but in other examples a wireless Internet connection to an Internet Service Provider may provide an Internet connection to one or more tablet 140 over 3G, 4G, LTE, WIMAX, or other cellular networking technologies. While each tablet at a station may access the Internet directly, in some examples a single tablet 140 at a fueling station having multiple dispensers and tablets may be equipped with one or more additional pieces of equipment (sometimes referred to as an antenna or “dongle”) to enable that tablet 140 to connect to the Internet 160 via 3G, 4G, or another wireless technology and to serve as a base station to share that Internet 160 connection with the other tablets via a second wireless or wired networking technology such as Wi-Fi, Bluetooth, Ethernet, or other networking protocol and/or medium.

In operation, a customer 110 may place his/her automobile at dispenser 120 for fueling. While at dispenser 120, customer 110 may initiate a purchase either of fuel via dispenser 120 or of other transactions, such as the purchase of retail items from store 130, via tablet 140. For example, customer 110 may begin a fuel purchase from dispenser 120 using payment mechanism 122. While fueling, customer 110 may examine information displayed on tablet 140. Tablet 140 may display information regarding instructions for its use, products available for purchase from store 130, sales or other promotional opportunities, third party sales of goods and/or services, charitable donation opportunities, entertainment options, and the like. Tablet 140 may additionally/alternatively replace the internal display of a fuel dispenser 120 and operate as the main payment interface at the dispenser. Customer 110 may interface with tablet 140 by touching the touch-enabled interface of tablet 140, for example by touching images, links or other depictions of a product of interest. Tablet 140 may permit customer 110 to select a number, type, or other parameter of items for purchase.

By way of example as to how tablet 140 may be used to make a non-fuel purchase, tablet 140 may offer customer 110 sandwiches for purchase, which may be made to order in a restaurant within store 130. Tablet 140 may therefore present customer 110 with a variety of options such as various breads, meats, cheeses, toppings, condiments, sizes, side orders, beverages, etc. for purchase in conjunction with a sandwich. After making a selection or selections by touching as indicated on tablet 140, customer 110 may use a payment mechanism 142 to pay for the items selected while refueling using dispenser 120. The purchased products may be prepared and made available for easy pickup within store 130, may be provided for pickup at a drive-through window associated with or adjacent to store 130, or may be delivered to customer 110 at dispenser 120. In this fashion, customer 110 has made an efficient acquisition of desired items during refueling downtime, which will be advantageous to both customer 110 and store 130.

System 100 may provide customer 110 with access to stores beyond store 130. For example, a connection 181 via Internet 160 to a first additional store 180 and/or a connection 183 via Internet 160 to a second additional store 182 may permit customer to purchase, acquire, donate, subscribe, or otherwise interact with first additional store 180 and/or second additional store 182. Any number of additional stores beyond first additional store 180 and second additional store 182 may be accessible in accordance with the present invention. Additional stores may be businesses or charities or other types of entities, and may be physically located near the fueling station implementing system 100, may be remotely located from fueling station, and/or may be entirely virtual entities. In some examples, an additional store may be any service accessible via Internet 160. In yet other examples, an additional store may be a social media platform that may permit a customer 110 to access his or her personal account or that may provide an account specific to the fueling station or even the individual dispenser 120; for example, a tablet 140 may permit a customer 110 to microblog his or her experience or thoughts while fueling, an experience that may be fun for the customer 110 while useful as a promotion for the fueling station.

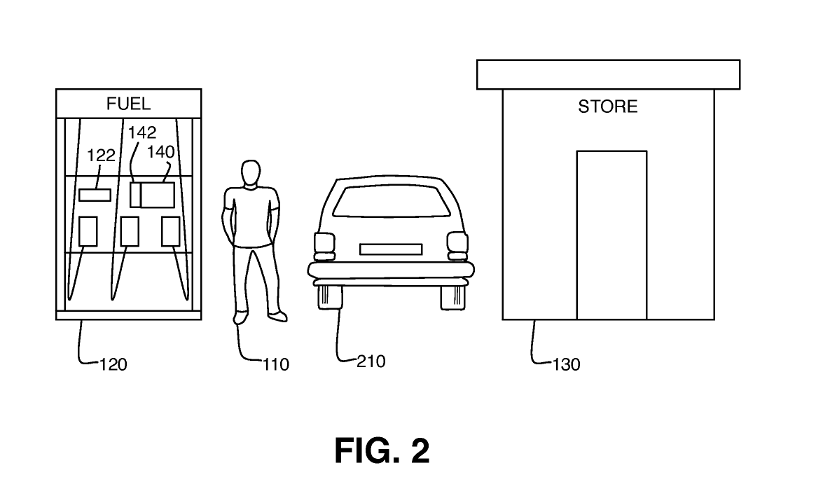

Referring now to FIG. 2, a further example of a system in accordance with the present invention is illustrated. A customer 110 may fuel an automobile 210 from fuel dispenser 120. Fuel dispenser 120 may have a payment mechanism 122, which may comprise any type of “pay-at-the-pump” system. Meanwhile, a tablet 140 may be affixed to dispenser 120 for ready availability to customer 110, convenience of mounting tablet 140, and to provide a readily available power source for tablet 140, although tablet 140 may alternatively be affixed at a location sufficiently near to dispenser 120 for convenient access by customer 110 during refueling. A payment mechanism 142 may be associated with tablet 140 for a convenient payment for items purchased using tablet 140. Payment mechanism 142 may be, for example, a magnetic card reader that is integral to or physically associated with tablet 140, but may comprise any other type of payment system, such as an NFC system, a barcode reader, a QR code reader, and/or a payment by cash, credit card, debit card, etc. if/when the selected physical items are picked up or delivered. Meanwhile, a store 130 may provide to customer 110 the any products selected and purchased via tablet 140. Store 130 may provide any of a variety of items, and may involve a restaurant for other retail service therein.

A tablet such as used and described herein may comprise any type of touch-enabled computing device capable of displaying information and receiving touch-based inputs indicating items of interest or selections for purchase. The display and A tablet used in conjunction with the present invention may be a general purpose tablet computer or a tablet specifically created for use in systems and methods in accordance with the present invention. Further, a tablet as used in conjunction with the present invention need not be entirely contained within a tablet form or size, but rather may comprise a touch-enabled screen affixed at a desired location with other components, such as a computer processor, memory, and storage, operably connected to the touch-enabled display to output the appropriate information and to receive inputs. A tablet may operate using any type of operating system, such as any of the various versions of the Android operating system, the Linux operating system, iOS, Microsoft Windows operating systems, or other computer operating systems that permit the graphical display of information and the receipt of touch-based inputs.

A touch-enabled display and/or a computer having a touch-enabled display used in conjunction with systems and methods in accordance with the present invention are not limited to any particular dimensions or technical specifications. One example of appropriate parameters for a touch-enabled display in accordance with the present invention is a 10.4 inch (measured diagonally) liquid crystal display backlit by an array of LED lights. Due to the wide range of illumination environments in which the invention may be practiced, the display may have a brightness rating of 800 or more nits. Touch-based inputs may be registered using a projective capacitive, surface capacitive, or resistive touch display. A touch-enabled display may be protected by a cover, such as an approximately 0.125 inch thick, anti-reflective pane of chemically strengthened glass, heat-tempered glass polycarbonate sheet, or other protective material. A touch controller, LED and/or LCD controller, and an industrial single board computer may control the operation of the touch-sensitive display. A cooling fan may also be provided to maintain a safe operating temperature. A tablet may be operated using a 12-volt direct current power supply, which may be electrically connected to a 110 volt alternating current power supply through the dispenser 120. Computer memory may be, for example, at least 1 GB of memory, and solid state storage may be, for example, at least 4 GB, although more or less than these amounts may be provided. Speakers may be provided to facilitate playing audio. A magnetic card reader, barcode scanner, QR code scanner, NFC interface, and/or other payment mechanism(s) may be provided to facilitate payments. Network connectivity may be provided in a variety of ways, such as using Ethernet cable, a wireless protocol (such as 802.11a/b/g/n), or any other wired or wireless technology or protocol.

A tablet used in conjunction with the present invention may be designed and manufactured to withstand the harsh environment anticipated when the tablet is affixed to or near a fuel dispenser. For example, a protective frontal frame, rear cover, and mounting bracket may be made of an appropriate metal or plastic to protect the tablet and/or payment device from weather, impact or other physical contact. Gaskets or other structures may be used as part of the frame to seal the tablet and/or payment device from any liquids such as rain, customer beverages, and/or fuel. One or more gaskets may also serve to protect the interior of a dispenser on which a tablet is mounted from moisture, dust, debris, or other damage due to the mounting of a tablet on dispenser. Mounting brackets or other mechanisms may be used to affix the tablet at the desired position with sufficient strength to withstand the rigors of use and to counter theft. To provide a desired level of safety for use in conjunction with fuel dispensing, the materials used in a protective frame and mounting mechanism may possess electrical properties and chemical resiliency as appropriate and required by various regulations, such as Underwriters Laboratories. Further, electrical connections may be mechanically reinforced, for example by using attachment mechanism and/or adhesives such as epoxies, to secure an electrical connection and to prevent sparking even if a powered tablet is physically demounted from a dispenser.

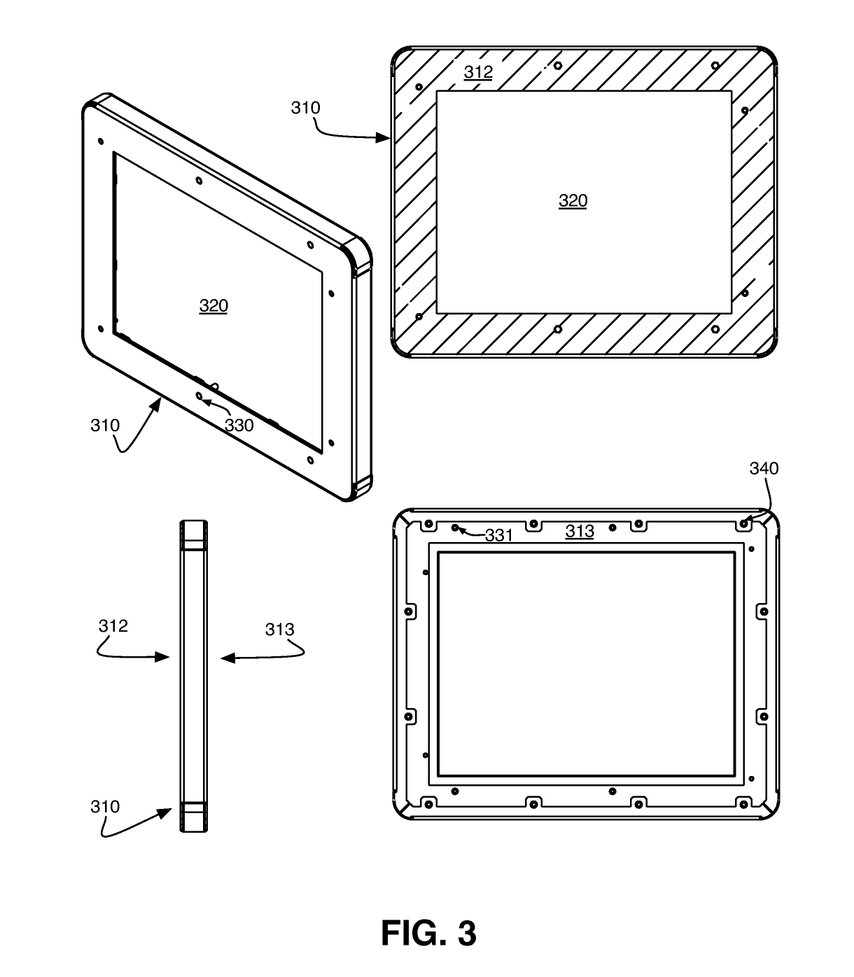

An example of a touch-enabled display located within a mounted tablet is illustrated in FIG. 3. In FIG. 3 the touch-enabled display 320 is contained within a protective frame 310. Protective frame 310 may be constructed of aluminum, plastic or other appropriate material. In many examples, frame 310 and other components of a tablet mounting structure may be constructed of 14 gauge, 16 gauge, 18 gauge, or other thickness aluminum or other metal with a folded metal welded construction. Protective frame 310 has a front side 312 and a back side 313. Touch-sensitive screen 320 is oriented towards the front 312 of frame 310 in order to provide visibility and access to a customer, while various electrical connections, communication interfaces, ventilation, an attachment mechanisms may be provided at the back 313 to protect those components from exposure to the elements or contact by a customer or other individual at a dispenser. One or more gaskets may be used to establish a secure and liquid impermeable seal between components of the protective frame 310 and the touch-sensitive screen 320, as well as between different components of frame and/or between frame 310 and dispenser. Gaskets may be of silicone, foam, rubber, and/or other materials.

The frame 310 may comprise a plurality of pieces assembled to effectively seal touch-sensitive screen 320 securely therein to provide protection from shock, theft, or other damage. A variety of connections 330 may hold the frame together, while a variety of connection mechanisms 340 may permit the frame 310 to be mounted upon a bracket or other retention mechanisms to retain the frame 310 to the dispenser or near the dispenser. The precise number and type of components used to form frame 310 and other mounting mechanisms and/or to join those components may vary from the examples depicted in the drawings and described herein.

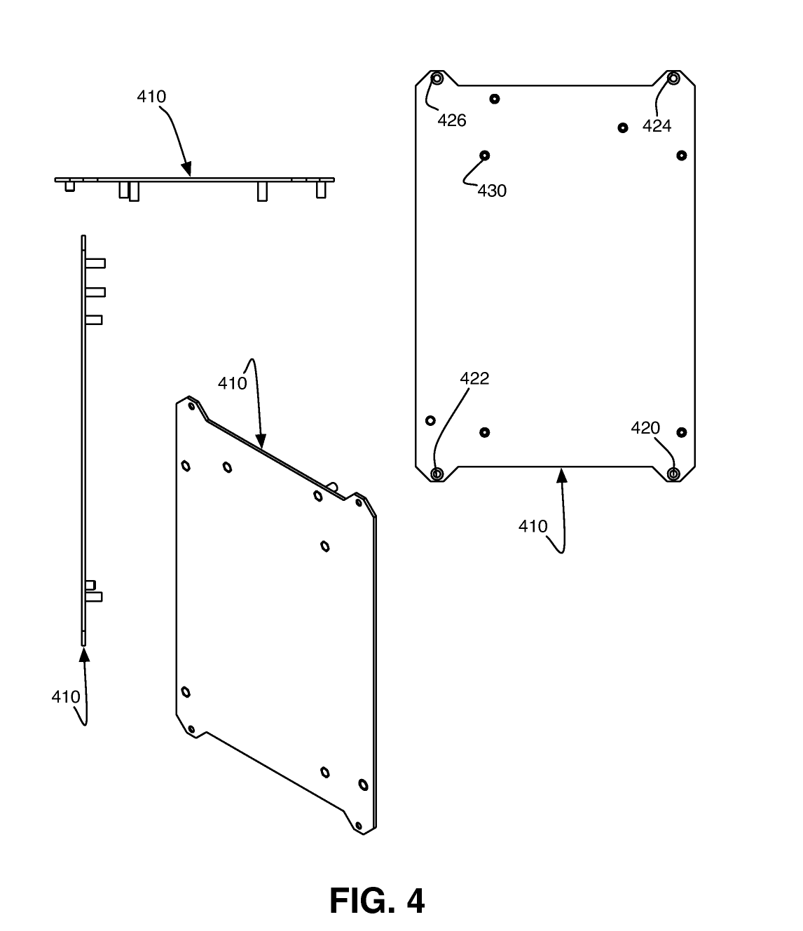

Referring now to FIG. 4, a plate 410 that may be used to mount or otherwise retain internal components. As can be seen in FIG. 4, a variety of holes may be provided to receive screws to retain plate 410 at a desired location. Plate 410 may provide a stand-off for desired orientation of the touch-sensitive screen and for appropriate ventilation of the various computing components. Plate 410 may be affixed to frame 310 and other components of a mounting system using connection mechanisms such as screws, For example, a first hole 420 may receive a first screw, a second hole 422 may receive a second screw, a third hole 424 may receive a third screw, and a fourth hole 426 may receive a fourth screw. Meanwhile, further holes 430 may receive further screws to retain the frame and touchscreen device to bracket 410.

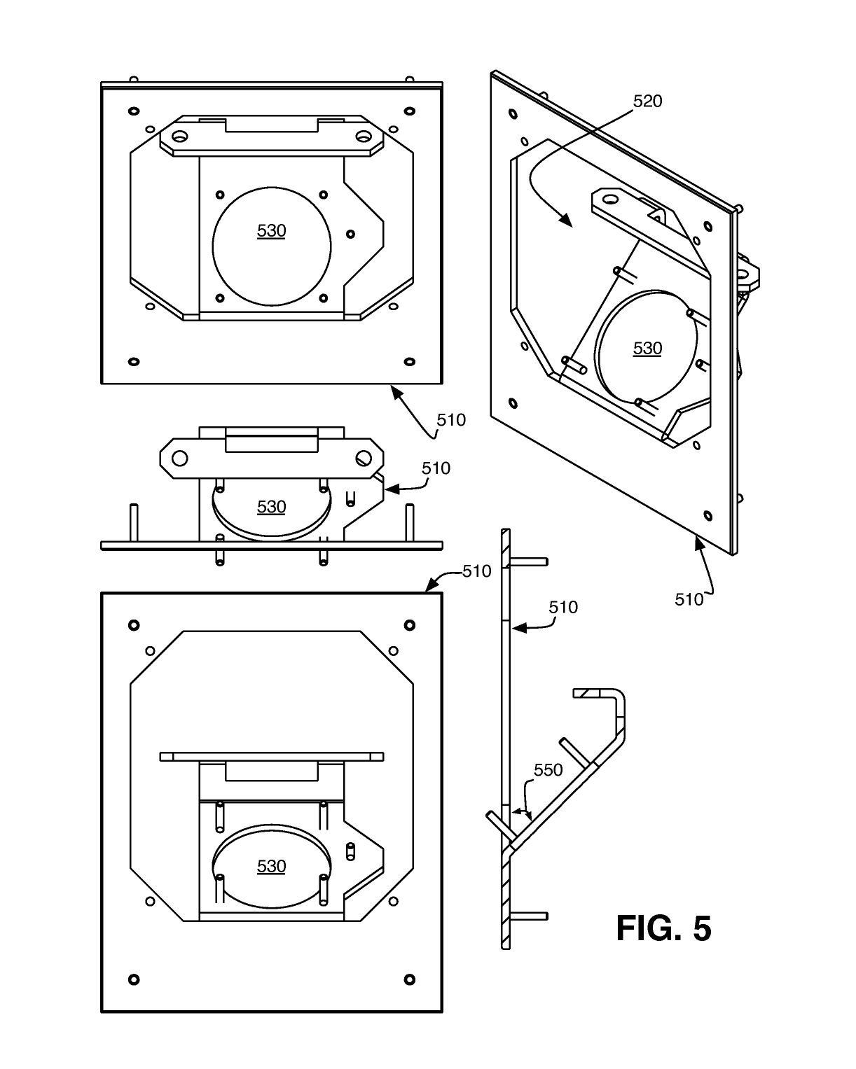

Referring now to FIG. 5, a mounting adaptor 510 is illustrated. Mounting adaptor 510 may be formed of a metal, plastic or other suitable material. In many examples, mounting adaptor 510 may be formed from a metal such as 14, 16, or 18 gauge aluminum or other metal. A hole 530 may receive a fan or blower to circulate air to cool the components of a tablet computing system in accordance with the present invention. Hole 530 may additionally, alternatively be used to receive power and communication connectors to interface with a tablet and to provide electrical power and data connectivity in order to permit or enhance the operation of systems and methods in accordance with the present invention.

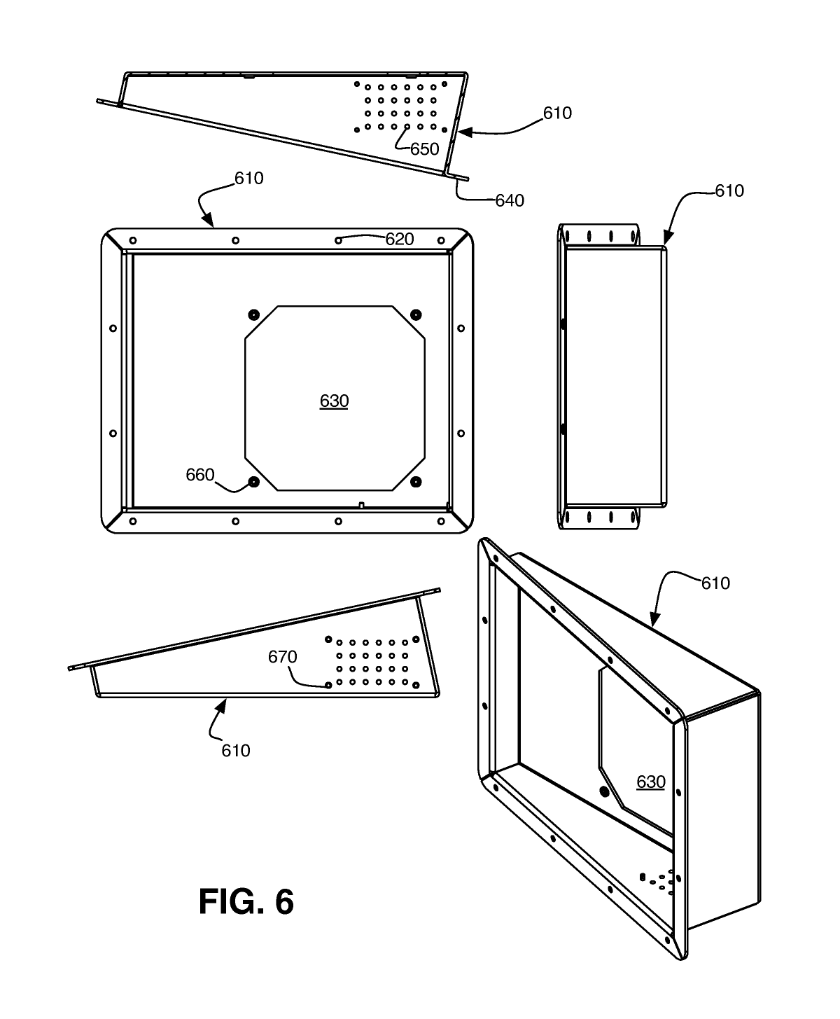

Referring now to FIG. 6, a cover 610 that may be affixed over mounting adaptor 310 is illustrated. Cover 610 may be constructed of metal, plastic or other suitable material. In many examples, cover 610 may be formed from a metal such as 14, 16 or 18 gauge aluminum or other metal. As can be seen in FIG. 6, a plurality of ventilation holes 650 may permit air to pass into the area of ventilation plate 510 to permit circulation around the electrical components of a tablet and to prevent overheating. A lip 640 may extend around ventilation cover 610 to permit ventilation cover 610 to be fitted securely onto plate 310 and to effectively in case and protect the rear portion of the tablet.

In assembling a frame 310, a component mounting plate 410, a cover 610, a touch-sensitive screen 320, and the various other components, various gaskets and/or sealants may be used to form a liquid-tight seal between the various components themselves, between the various components and the touch-enabled display 320, and between the various components and the fuel dispenser.

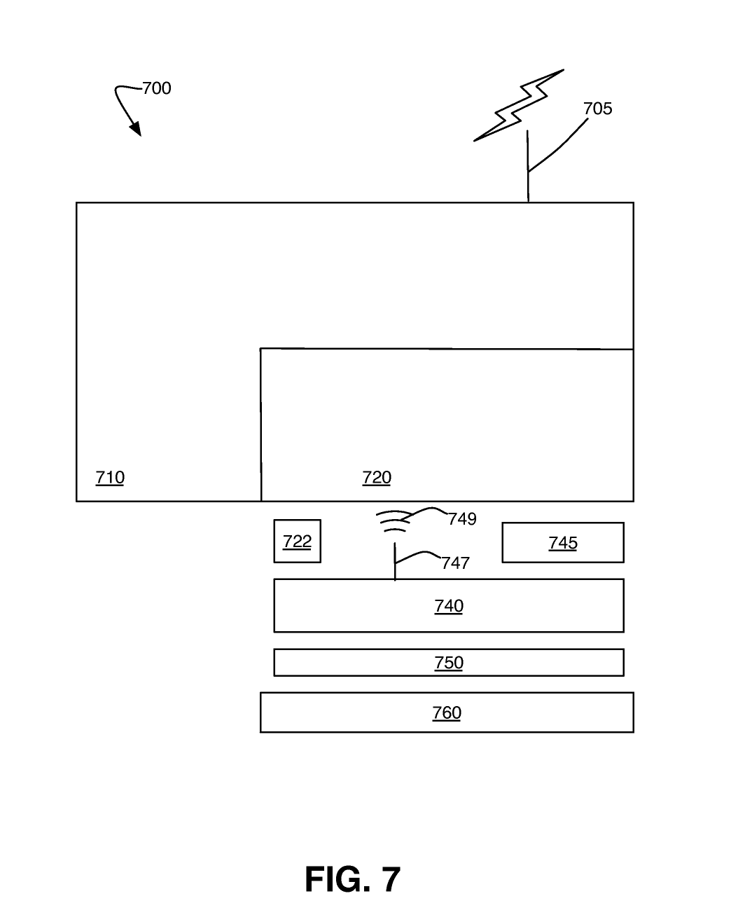

Referring now to FIG. 7, an example schematic of a system 700 in accordance with the present invention is illustrated. A dispenser 710 may be any type of fuel dispenser on which a tablet 740 is to be mounted. A power connection 705 may be a 110 volt alternating current connection that powers the operations of dispenser in dispensing fuel to customers, keeping records of transactions, supporting payment processing, etc. Dispenser 710 may also have appropriate data connections for payment processing (if dispenser provides a ‘pay-at-the-pump’ system) and may provide connections to dispense fuel from one or more fuel reservoir to the tank of customer's vehicle. An access bay 720 may be provided within dispenser 710 to receive, retain, and/or connect to a tablet 740. Access bay 720 may be provided with a removable panel to cover bay 720 if tablet 740 is not installed in accordance with the present invention.

A 12 volt direct current power source 722 may receive 110 volt alternating current electrical power either directly or indirectly from AC power source 705 and provide 12 volt DC power to tablet 740. Of course, in some examples in accordance with the present invention a tablet 740 may utilize a different direct current voltage or may utilize alternating current of any voltage. A fan 745 may optionally circulate air to cool tablet 740 and the computing components located within tablet, as well as power supply 722. In some examples, fan 745 may require a power supply such as 12 volt DC power supply 722, but in other examples fan 745 may be able to receive electrical power directly or indirectly from power source 705 of dispenser 710.

At least one antenna 747 may exchange wireless signals 748 between tablet 740 and at least one other wireless-enabled computing device. Wireless signals 748 may be used to access the Internet or other computing network via a wireless router, a cellular network data tower, or other devices. Additionally/alternatively, wireless signals 748 may be used to exchange data communications with other tablets operating at a fueling station, potentially to share a data connection with those other tablets. In the event of a shared data connection, the tablet serving as a “hub” to share an Internet connection may use two (or more) antennas, for example one antenna to communicate with a cellular data network according to an appropriate protocol and a second antenna to exchange communications with other tablets.

A protective enclosure 760 may secure tablet 740 within access bay 720 of dispenser 710. Protective enclosure 760 may be formed of any type of material, such as, but not limited to, aluminum. Protective enclosure 760 may protect tablet 740 as well as the interior of dispenser 710 from tampering and from environmental conditions. One or more gasket 750 may provide a seal with the exterior of dispenser 710 around access bay 720, as well as optionally between components of protective cover 760 and/or between protective cover 760 and tablet 740.

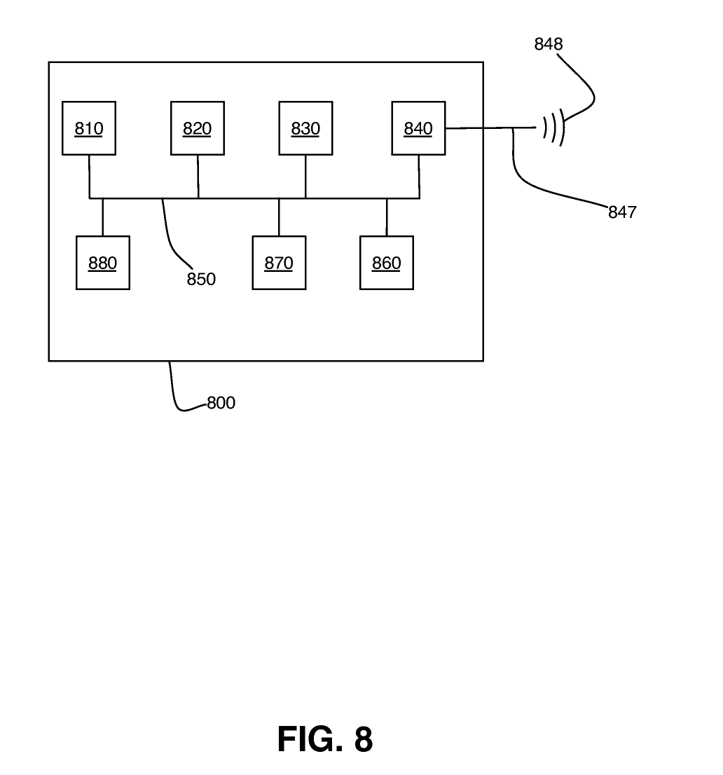

Referring now to FIG. 8, exemplary computing components of a tablet 800 that may be used in systems and methods in accordance with the present invention is illustrated. One or more computer processor 810 may execute computer-readable code to perform operations such as those described herein. One or more data bus 850 may operably connect processor to computer memory 820, computer storage 830, communication component 840, output component 860, input component 870, and/or payment component 880. Processor 810 may execute code maintained in a non-transitory form in memory 820, in storage 830, and/or at a remote computing device accessible via communication component 840. Processor 810 may similarly maintain records of the operation of tablet 800 in storage 830 and/or at a remote computing device accessible via communication component 840.

Communication component 840 may implement one or more protocol to exchange data communications, such as may use any protocol and/or medium, to exchange data over wired or wireless connections. In the example of FIG. 8, communication component 840 interfaces with an antenna 847 that exchanges wireless communications 848 with other computing devices (not shown), but other types of communications (whether wired or wireless) may be used instead of or in addition to wireless communications 848 within the scope of the present invention. One or more output component 860 may control the output of information as directed by processor 810. One or more output component 860 may control or include a display screen, audio speaker(s), a printer, and/or any other type of device(s) that may operate under the direction of processor 810 to render information into a form perceptible to a customer. One or more input component 870 may control or include a touch screen, button, or any other type of device(s) that may operate under the direction of processor to receive inputs from a customer. Processor 810 may interact with a customer in accordance with the present invention by coordinating the information output to a customer via output component 860 with the inputs (indicating selections, etc.) of customer via input component 870. A payment component 880 may optionally be integral to tablet 800 (although payment component may additionally/alternatively be a discreet component operably connected to tablet 800 in any manner, such as through a communication component 840.

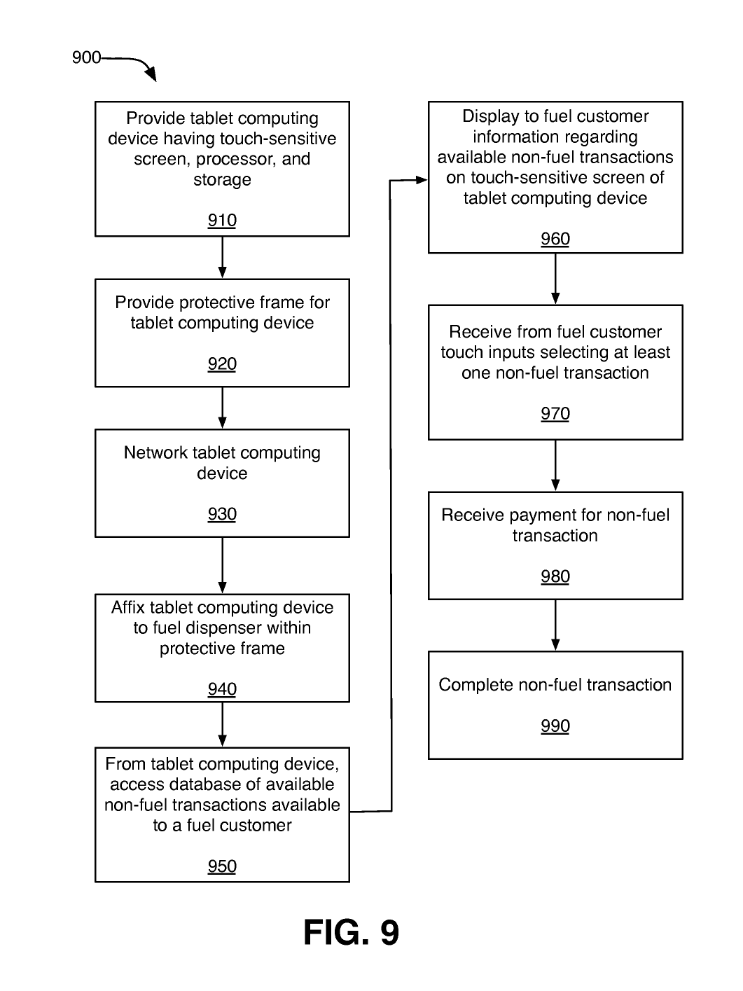

Referring now to FIG. 9, an example of a method 900 in accordance with the present invention for facilitating non-fuel transactions at a fuel dispenser is illustrated. A tablet computing device to may be provided in step 910. Step 910 may provide a tablet computing device having a touch-sensitive screen, a processor, network connection(s), memory, and/or storage. Memory and/or storage, whether integral to tablet computing device or accessed via a network, may retain computer executable code in a non-transitory form to cause the processor to operate in accordance with the methods of the present invention.

Protective frame for tablet computing device may be provided in step 920. The protective frame provided in step 920 may be formed of one or more materials, such as aluminum and a polycarbonate sheet permitting a non-fuel customer to see and touch-activate the touch-sensitive screen of the tablet computing device. One example of an appropriate protective frame is described herein, but other types and varieties of protective frames may be used in accordance with the present invention.

The tablet computing device may be connected to a data network, such as the Internet, in step 930. Step 930 may network tablet computing device using any wired or wireless medium and/or protocol. Step 930 may direct the tablet computing device directly to the Internet, or may connect the tablet computing device to the Internet through a router or other local network device. Step 930 may also provide a firewall and/or other network security functions.

The tablet computing device may be affixed to a fuel dispenser within the protective frame in step 940. Step 940 may involve connecting the tablet computing device to a power source and/or providing a fan or other cooling system to power the tablet computing device and to maintain an appropriate operating temperature for the tablet computing device.

In step 950 the tablet computing device may access at least one database of available non-fuel transactions available to the fuel customer. The database accessed in step 950 may be an inventory of locally available items within a store associated with the fuel dispenser, may involve non-local transactions, and/or may involve non-sale or non-commercial transactions. The database(s) accessed in step 950 may be maintained in the tablet computing device, in a store affiliated with the fuel dispenser, and/or may be located remotely from the dispenser and accessed over a data network.

In step 960 the touch-sensitive screen of the tablet computing device may used to display information regarding available non-fuel transactions to the fuel customer. Some examples of non-fuel transactions that may be available to a fuel customer are described herein. In some examples of methods in accordance with the present invention, step 960 may operate iteratively with step 970 (described below) to display a category and/or range of non-fuel transactions available and to permit a fuel customer to access one or more of a large number of available non-fuel transactions by indicating the type of transaction the customer is interested in conducting. For example, a fuel customer may be presented with entertainment options, food options, loyalty club options, charitable options, business partner options, etc., and then may explore each of those categories further to select individual non-fuel transaction(s) of interest to the fuel customer.

The fuel customer may indicate a selection of a non-fuel transaction by touching the touch-sensitive screen in step 970. Step 970 may receive touch inputs from the fuel customer selecting at least one non-fuel transaction. Step 970 may involve selecting an individual non-fuel transaction, selecting a category of non-fuel transactions, requesting additional information regarding a transaction, etc. Step 970 may operate iteratively in conjunction with step 960 of displaying information describing a non-fuel transaction(s).

If a payment is required from the customer for the selected non-fuel transaction, a payment may be received in step 980. Step 980 may receive a payment for the non-fuel transaction(s) from fuel customer through any type of payment mechanism, such as a credit card reader, an NFC system, a barcode scanner, a QR code scanner, a cash payment, etc.

Method 900 may conclude in step 990 by completing the non-fuel transaction. Step 990 may involve delivering or making available for pick-up any items purchased, providing a validation code, enrolling the fuel customer in a loyalty program, transferring a donation from the fuel customer to a selected charity, providing media files to the fuel customer, etc.

Systems and methods in accordance with the present invention are not limited to the specific materials, dimensions, operating systems, communication protocols, and technical parameters given in the examples herein. Nor is the present invention limited to the exemplary types of items available for sale, rent, access, donation, acquisition, or otherwise described in examples herein. Commercial and non-commercial transactions beyond the purchasing of non-fuel items may be implemented using systems and methods in accordance with the present invention. Various types of computing devices, operating systems, networks, and network technologies may be used in accordance with the present invention.

1. A system to facilitate non-fuel transactions by a fuel customer at a fuel dispenser, the system comprising:
a non-fuel item payment mechanism distinct from any fuel payment mechanism associated with the fuel dispenser;
a tablet computing device having data connections with at least the non-fuel transaction payment mechanism and an external database of non-fuel transactions, the tablet computing device comprising at least a touch-sensitive display and a computer processor executing computer readable code retained in a non-transitory medium, the computer readable code causing the computer processor of the tablet computing device to coordinate the display of information to the fuel customer by the touch-sensitive display, the receipt of touch inputs from the fuel customer by the touch-sensitive display, and the processing of payments for non-fuel transactions by the non-fuel transaction payment mechanism to perform a method of:
displaying information on the touch-sensitive display describing a plurality of non-fuel transactions available,
receiving touch inputs on the touch-sensitive display from the customer selecting at least one non-fuel transaction,
processing a payment for the at least one non-fuel transaction selected by the customer, the payment made using the non-fuel transaction payment mechanism, and
coordinating the performance of non-fuel transactions with the fuel customer;
an enclosure that seals the tablet computing device from liquids and retains the tablet computer in an orientation accessible by a customer at the fuel dispenser, the enclosure affixing the tablet computing device to the fuel dispenser; and
at least one database of non-fuel transactions available to the fuel customer, the at least one database of non-fuel transactions accessible by the computer processor of the tablet computing device and used by the tablet computing device to identify non-fuel transactions available the fuel customer.

2. The system of claim 1, wherein the at least one database of non-fuel transactions comprises a database of items available for purchase from a store associated with the fuel dispenser.

3. The system of claim 1, wherein the at least one database of non-fuel transactions comprises a database of loyalty program enrollment options.

4. The system of claim 1, wherein the at least one database of non-fuel transactions comprises a database of promotional specials available from third parties.

5. The system of claim 1, wherein the at least one database of non-fuel transactions comprises charity donation opportunities.

6. The system of claim 1, wherein the at least one database of nonfuel transactions comprises at least a first database of items available for purchase from a store associated with the fuel dispenser and a second database of transactions available from third parties.

7. The system of claim 6, wherein the first database provides a menu of freshly prepared food items available for purchase, and wherein the tablet computing device receives food preparation selections from the fuel customer and communicates the food preparation selections to the store associated with the fuel dispenser.

8. The system of claim 6, wherein the second database provides a plurality of entertainment options available to the fuel customer.

9. The system of claim 6, wherein the second database provides a plurality of intangible purchase options available to the fuel customer.

10. A method for providing non-fuel items for sale to a fuel customer at a fuel dispenser, the method comprising:
displaying information regarding non-fuel items available for purchase on a touch-sensitive display while a customer dispenses fuel to refuel a vehicle, the touch-sensitive display being affixed to the fuel dispenser used to dispense fuel;
receiving at least one touch input from a customer selecting at least one non-fuel item to be purchased using the touch-sensitive display;
processing a payment for the at least one non-fuel item selected for purchase using a payment mechanism associated with the touch-sensitive display; and
coordinating the delivery of the at least one non-fuel item purchased by the fuel customer.

11. The method of claim 10, wherein coordinating the delivery of the at least one non-fuel item purchased by the fuel customer comprises initiating one of an in-store pick-up, a drive through window pick-up, and a delivery to the fuel customer at the fuel dispenser.

12. The method of claim 11, further comprising maintaining at least one database of non-fuel items available for purchase and updating the at least one database of non-fuel items available for purchase based upon purchases made by other customers.

13. The method of claim 12, wherein the touch-sensitive display comprises a portion of a tablet computing device.

14. The method of claim 13, further comprising affixing the tablet computing device to the fuel dispenser within a protective frame.

15. The method of claim 14, wherein affixing the tablet computing device to the fuel dispenser within a protective frame comprises securing the touch-sensitive screen beneath a polycarbonate sheet retained within a welded aluminum frame attached to the fuel dispenser with a gasket sealing the welded aluminum frame over the tablet computing device.

16. A system for conducting non-fuel transactions at a fuel dispenser, the system comprising:
a fuel dispenser that provides fuel to a fuel customer;
a tablet computing device having a processor that executes computer executable code retained in a non-transitory medium on the tablet computing device, a touch-sensitive screen that displays information regarding available non-fuel transaction to the fuel customer and receives inputs from the fuel customer selecting non-fuel transactions;
at least one database of non-fuel transactions available to the fuel customer, the at least one database of non-fuel transactions not stored on the tablet computing device;
at least one communication interface between the tablet computing device and the at least one database of non-fuel transactions available to the fuel customer, the tablet computing device receiving information regarding non-fuel transactions from the at least one database of non-fuel items over the at least one communication interface;
a protective case that affixes the tablet computing device to the fuel dispenser, the protective case completely enclosing the tablet computing device to the fuel customer and providing a polycarbonate sheet through which the fuel customer may interact with the touch-sensitive screen of the tablet computing device.

17. The system for conducting non-fuel transactions at a fuel dispenser of claim 16, the system further comprising a non-fuel transaction payment mechanism that receives a payment from a fuel customer for a non-fuel transaction, the non-fuel payment mechanism being distinct from any fuel payment mechanism of the fuel dispenser.

18. The system for conducting non-fuel transactions at a fuel dispenser of claim 17, wherein the at least one database of non-fuel transactions comprises a first database of local transactions and a second database of non-local transactions.

19. The system for conducting non-fuel transactions at a fuel dispenser of claim 18, wherein the first database of local transactions contains a plurality of items available for purchase within a store associated with the fuel dispenser.

20. The system for conducting non-fuel transactions of claim 19, wherein the second database of non-local transactions contains transactions available from a party other than a store associated with the fuel dispenser.
